(19) United States
(12) Patent Application Publication
(10) Pub. No.: US 2016/0072900 A1
(43) Pub. Date: Mar. 10, 2016

(54) METHOD AND SYSTEM FOR THE GENERATION OF CONTEXT AWARE SERVICES BASED ON CROWD SOURCING

(71) Applicant: UMM AL-QURA UNIVERSITY, Makkah (SA)

(72) Inventors: Mohamed Abdur RAHMAN, Makkah (SA); Faizan Ur Rehman, Makkah (SA); Syed Osama Hussain, Makkah (SA); Akhlaq Ahmed, Makkah (SA); Saleh Basalamah, Makkah (SA)

(73) Assignee: UMM AL-QURA UNIVERSITY, Makkah (SA)

(21) Appl. No.: 14/850,523

(22) Filed: Sep. 10, 2015

Related U.S. Application Data
(60) Provisional application No. 62/048,552, filed on Sep. 10, 2014.

(51) Int. Cl. H04L 29/08; G06F 17/30; H04W 4/02

(52) U.S. Cl. CPC H04L 67/16; H04W 4/021; H04L 67/306; G06F 17/30876

(57) ABSTRACT

A context aware service generation method and system that stores a list of events, stores one or more dates and times each corresponding to an event, receives user data indicating a state of the user, determines whether a current date and time corresponds with a date and time stored in the memory, determines an event in response to determining that the current date and time corresponds with the date and time, determines a user context based on the user data, and generates a subset of services based on the user context and the event. The method uses crowd sourcing technique to generate services to the users.

### CROSS-REFERENCE TO RELATED APPLICATIONS

This application claims the benefit of priority from U.S. Provisional Application No. 62/048,552 filed Sep. 10, 2014, the entire contents of which are incorporated herein by reference.

### BACKGROUND

During Hajj millions of visitors travel to Saudi Arabia to perform the Islamic pilgrimage known as Hajj as described in “Dramatic rise in Umrah arrivals,” http://www.arabnews.com/saudi-arabia/dramatic-rise-umrah-arrivals, incorporated herein by reference in its entirety. Some of the services developed for Hajj are described in N. A. Koshak, “A GIS-Based Spatial-Temporal Visualization of Pedestrian Groups Movement to and from Jamart Area,” Proceedings of CUPUM'05 (International conference on Computers in Urban Planning and Urban Management, Jun. 29-Jul. 1, 2005, London, United Kingdom, N. A. Koshak, “Developing a Web-Based Geographic Information System for Hajj Traffic Plan,” Journal of Urban Planning Research, vol. 6, issue 6, May 2006, N. A. Koshak and A. Fouda, “Analyzing Pedestrian Movement in Mataf Using GPS and GIS to Support Space Redesign,” Proceedings of the 9^{th} International Conference on Design and Decision Support Systems in Architecture and Urban Planning (DDSS), 2008, A. Alharthy and N. A. Koshak, “Automatic Extraction of Tents during Hajj from Airborne Images to Support Land Use Optimization,” Automation in Construction International Journal, vol. 16, no.1, 2007, each incorporated herein by reference in its entirety. Each visitor needs a set of services. Some visitors speak different languages, and have different health status, providing each pilgrim with a personalized set of services is very important. Mobile devices are becoming widely equipped with a set of sensors that can capture temperature, location and heart rate. Some of the methods that use context aware data are described in: eMarketer report, “Worldwide Mobile Phone Users: H1 2014 Forecast and Comparative Estimates,” http://www.emarketer.com/Article/Smartphone-Users-Worldwide-Will-Total-175-Billion-2014/1010536, C. Dobre, “A platform to Support Context-Aware Mobile Applications,” Control Systems and Computer Science (CSCS), 2013 19th International Conference, pp. 121-128, 29-31 May 2013, M. A. Rahman, A. E. Saddik, and W. Gueaieb, “Building Dynamic Social Network from Sensory Data Feed,” IEEE Transactions on Instrumentation and Measurement, vol. 59, no. 5, pp. 1327-1341, 2010, M. A. Rahman, M. S. Hossain and A. E. Saddik, “Context-aware multimedia services modeling: an e-health perspective, Multimedia Tools Applications, DOI 10.1007/s11042-013-1595-5, X. Hu, “Context-Dependent Adaptability in Crowd Behavior Simulation,” Information Reuse and Integration, 2006 IEEE International Conference, pp.214-219,16-18 September 2006, doi:10.1109/IRI.2006.252415, D. Zhang, “ Context-aware computing in the era of crowd sensing from personal and space context to social and community context,” Pervasive Computing and Communication Workshops (PERCOM Workshops), doi:10.1109/PerCom W.2013.6529446, M. A. Rahman, A. E. Saddik, and W. Gueaieb, “Augmenting Context Awareness by Combining Body Sensor Networks and Social Networks, IEEE Transactions on Instrumetnation and Measurement, vol. 60, no. 2, pp. 345-353, 2011, M. A. Rahman, S. Hamdan, A. E. Saddik and W. Gueaieb, Context-Aware Social Networks Mashup: A Personalized Web Perspective,” in Proc. of the IEEE Instrumentation and Measurement Technology Conference (I2MTC'2010), pp. 1228-1233, Austin, Tex., USA, May 3-6, 2010, M. A. Rahman, H. N. Kim, A. E. Saddik, and W. Gueaieb, “A context-aware Multimedia Framework toward Personal Social Network Services, Journal of Multimedia Tools and Applications, Springer, US, vol. 61, no. 3, pp. 1-31,2012, M. A. Rahman and A. E. Saddik, Modeling e-Health Framework towards Personalized and Context-Aware Multimedia Services, Handbook of Innovative Medical Technologies, Springer, ISBN 978-1-4614-8494-3, and F. Ullah, A. Khelil, A. A. Sheikh, E. Felemban and H. Bojan “Towards Automated self-tagging in Emergency Health Cases,” Proc. of the 15^{th} IEEE International Conference on e-Health Networking, Application & Services (Healthcom), 2013 each incorporated herein by reference in its entirety. Due to their small size, low price and high precision, mobile devices are commonly available to pilgrims. In addition, some services are also related to certain dates and locations. Accordingly, as recognized by the present inventor, it will be beneficial to provide the users with a set of services associated with their context.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to a context aware services generation method that stores a list of events, stores one or more dates and times each corresponding to an event, receives user data indicating a state of the user, determines whether a current date and time corresponds with a date and time stored in the memory, determines an event in response to determining that the current date and time corresponds with the date and time, determines a user context based on the user data, and generates a subset of services based on the user context and the event.

A system for generating context aware services is provided that includes storing in a server a list of events, storing one or more dates and times each corresponding to an event, receiving user data indicating a state of the user, determining whether a current date and time corresponds with a date and time stored in the memory, determining an event in response to determining that the current date and time corresponds with the date and time, determining a user context based on the user data, and generating a subset of services based on the user context and the event.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a context aware services generation system according to one example;

FIG. 2 is a schematic diagram of a context aware services generation system according to one example;

FIG. 3 is a block diagram representation of a context aware services generation system architecture according to one example;

FIG. 4 is a block diagram representation of a context aware services generation system architecture according to one example;

FIG. 5 is an exemplary schematic map showing different predetermined areas according to one example;

FIG. 6 is an exemplary schematic of an identification information form according to one example;

FIG. 7 shows logs for two users according to one example;

FIG. 8 shows a merged user log according to one example;

FIG. 9 is an exemplary flow chart for user context detection of a context aware services generation system according to one example;

FIG. 10 is a chart showing a user context according to one example;

FIG. 11 is a block diagram representation of services generated by a context aware services generation system according to one example;

FIG. 12 is an exemplary flow chart for community of interest of a context aware services generation system according to one example;

FIG. 13 shows an exemplary table to store information corresponding to an event;

FIG. 14 is an exemplary flow chart of a context aware services generation system according to one example;

FIG. 15 is an exemplary flow chart of a context aware services generation system according to one example;

FIG. 16 is a block diagram representation of tracking used by a context aware services generation system according to one example;

FIG. 17 is an exemplary flow chart of a context aware services generation system according to one example;

FIG. 18A, FIG. 18B, FIG. 18C and FIG. 18D is an exemplary user interface according to one example; and

FIG. 19 is an exemplary block diagram of a server according to one example.

### DETAILED DESCRIPTION

Referring now to the drawings, wherein like reference numerals designate identical or corresponding parts throughout several views, the following description relates to a context aware services generation system and associated methodology for providing services to a user based on the user contextual data using crowd sourcing.

Many different events involve large crowds from different countries such as pilgrims or sporting events. For instance, in the Islamic pilgrimage known as Hajj, millions of visitors from all over the world come to Saudi Arabia. The pilgrims face problems of residence, food, health, navigational paths, and currency exchange. Some visitors come from different countries, speak different languages and have different health status, thus providing each visitor with a personalized set of services is very important. A smartphone equipped with high-speed communication capability, which is commonplace, can capture a user context continuously and provide a subset of services to the user that corresponds to their current needs. The subset of services available to the user is dependent on an event, the user context, the user location and the current date and time. The user may be a pilgrim, a tourist or the like involved in the event.

In addition, smartphone with 4G internet connection capability have recently attracted a lot of users such as pilgrims to stay connected with different social networks while they are performing their pilgrimage. Users may share their ideas, experiences over social networks such as Facebook, Twitter, LinkedIn or the like. The social networks allow the users to share ideas, and experiences including spatio-temporal data either publicly or with a community of interest (COI) in real time, which leaves a rich trail of information. Many blogs and discussion groups are active over the social networks for information, guidance and services about the Hajj and Umrah. The social networks thereby serve as crowd sourcing resources and by analyzing the crowd sourced data streams and then validating the content, one can extract knowledge about dynamic conditions of Hajj and Umrah pilgrimage. Real time social network data can provide the pilgrims an option to share their experiences as a source of information and interactive guidance in emergencies. For example, the users during their movement from location A to location B can discuss and share the encountered problems over the social networks. For example, the users may share information about a car accident on a road from the location A to the location B. The system may use the information to alert other users about the car accident. The system may compute alternative directions. Alternative directions may be sent to the other users so they avoid the problems. In other situations, organizers may use the crowd-sourced data to track the users. For example, in case of a group of users showing symptoms for food poisoning, the system may use user social activity such as check in at restaurants to determine a possible source of the poisoning.

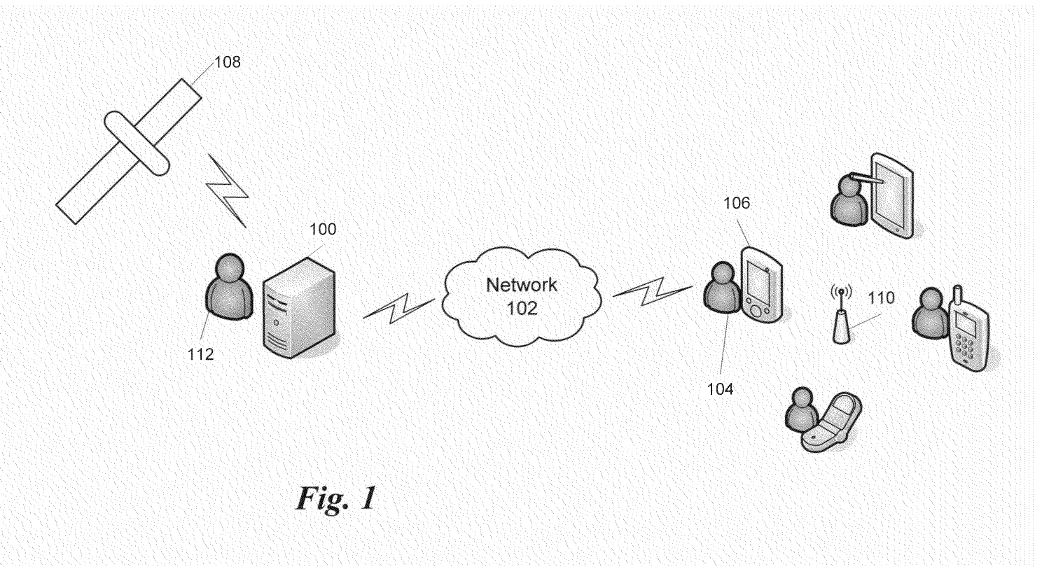

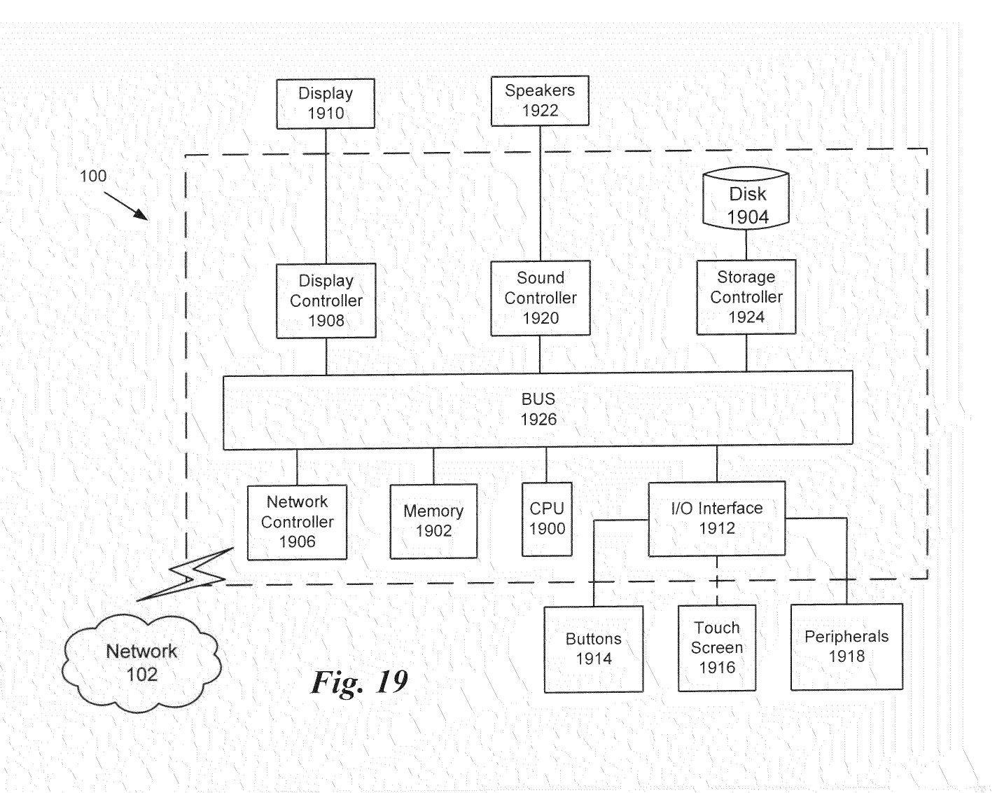

FIG. 1 shows a schematic diagram of the context aware services generation system according to an exemplary embodiment. In FIG. 1, the user 104 may possess a mobile device 106. The mobile device 106 is connected to a server 100 via a network 102. The server includes a network controller 1906 as shown in FIG. 19. The mobile device 106 represents one or mobile devices connected to the server 100 via the network 102. The network 102 is any network that allows the mobile devices and servers to communicate information with each other over computer networks. The server 100 is one or more servers that responds to requests across a computer network and generates the subset of services. The mobile device 106 communicates with the server 100 via the network 102. The mobile device 106 may also communicate with the server 100 via a satellite 108. The mobile device 106 may include processing circuitry, communication circuitry, a camera, and a memory. In selected embodiments, the mobile device 106 may be further equipped with a humidity, an orientation, a gravity, an accelerometer, a temperature, a heart rate, a magnetic field, a linear acceleration, a rotation vector, a proximity, a pressure, and a light sensor. The mobile device 106 may be further equipped with a gyroscope. Readings from the sensors maybe transmitted to the server 100 via the network 102. The server 100 receives information about the mobile device 106 location. The server 100 stores a list of events, one or more dates and times, and predetermined areas. The server 100 includes a CPU 1900 and a memory 1902 as shown in FIG. 19.

The mobile device 106 location can be determined via various satellite 108 based positioning systems known in the art, as GPS (Global Positioning System). For example, the mobile device 106 can include a location detector. The location detector may be a GPS module to detect a current geographical location of the mobile device 106. In other embodiments, the mobile device 106 location is determined via a cellular tower 110 with which communication has been established using current technologies such as GSM (Global System for Mobile) localization, triangulation, blue-tooth, hotspots, WiFi detection, or other methods as would be understood to one of ordinary skill in the art. In other embodiments, the mobile device 106 location is determined by the network 102. In particular, it may detect a location of the mobile device 106 as a network address on the network 102. The mobile device 106 location corresponds to the user location. Once the mobile device 106 location is determined by any of the techniques described above or other methods as known in the art, the user location is likely known. Then in response to a query from the server 100, the mobile device 106 sends the user location to the server 100 via the network 102. The mobile device 106 location may be checked periodically every 1 minute, 5 minutes or any other suitable period. In other embodiments, the mobile device 106 location may be checked only during the specific date and time of interest. As described further below, the mobile device 106 may connect with the server 100 to receive information based on the mobile device 106 location. An administrator 112 may update information in the server 100. The administrator 112 may be an authorized individual from the government, organizers or the like.

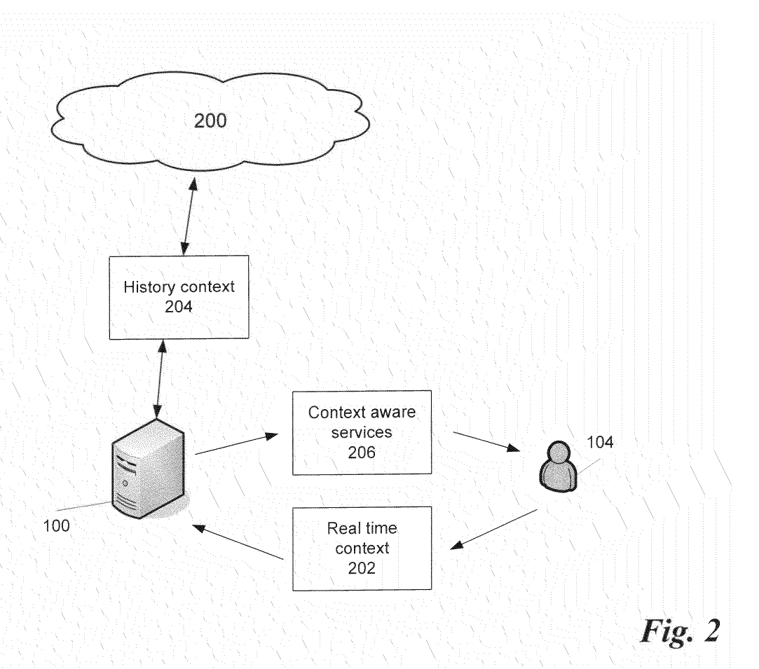

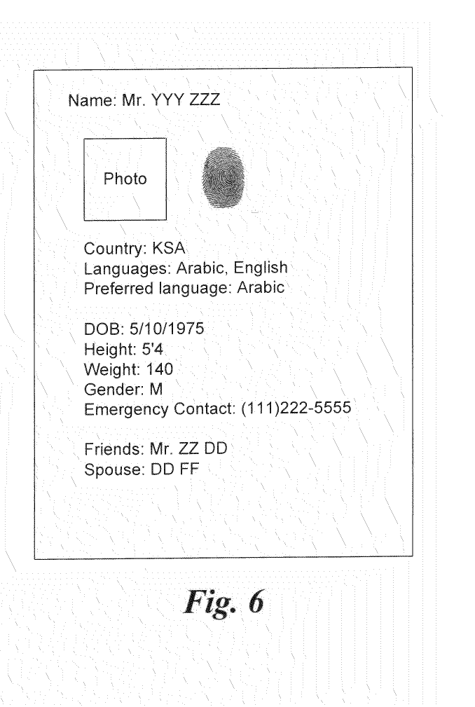

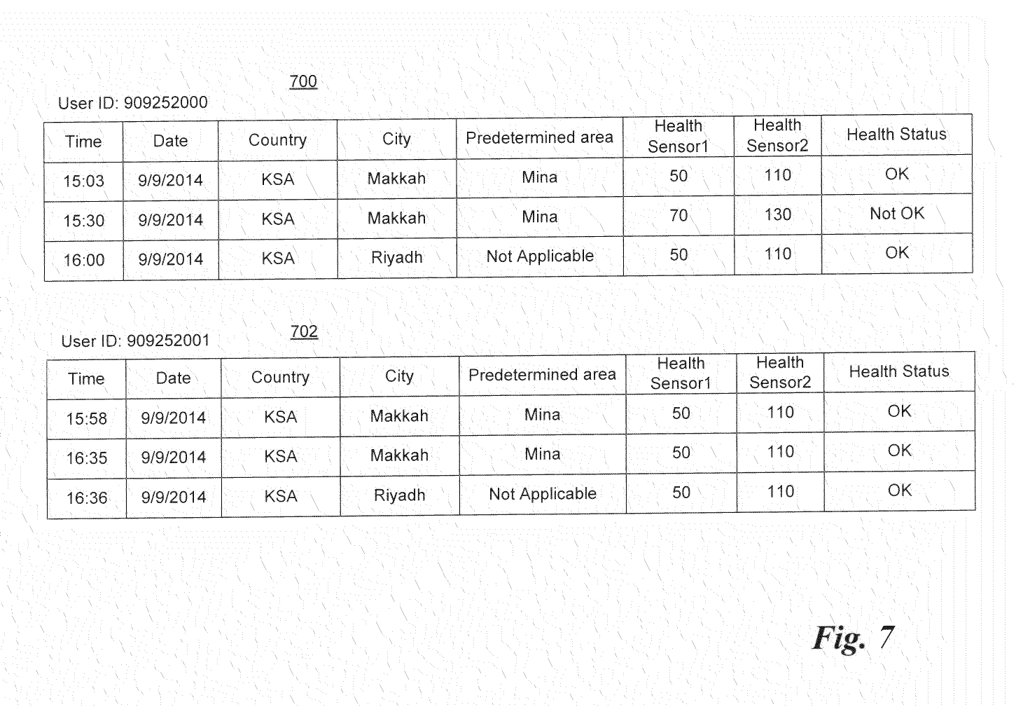

FIG. 2 is an exemplary block diagram representation of the system architecture. A user context manager collects real time context 202 from the user 104. The real time context 202 may be collected using health sensors. The health sensors may collect a plurality of physiological readings. The physiological readings may include a pulse rate, a heartbeat rate, a blood pressure, ECG and the like. The real time context may also include ambient information such as a temperature. The user context manager may also handle a history context 204 stored in a cloud storage system 200. The history context 204 may include a user profile as explained later and shown in FIG. 6. In addition, the history context 204 may also include past stored contextual data as explained later and shown in FIG. 7. The history context 204 may be collected from a plurality of users. The server 100 may download the history context 204 from the cloud storage system 200. The server may also upload to the cloud storage system 200 an updated history context 204. As explained later, using the history context 204 and the real time context 202, the server 100 may generate context aware services 206 for the user 104.

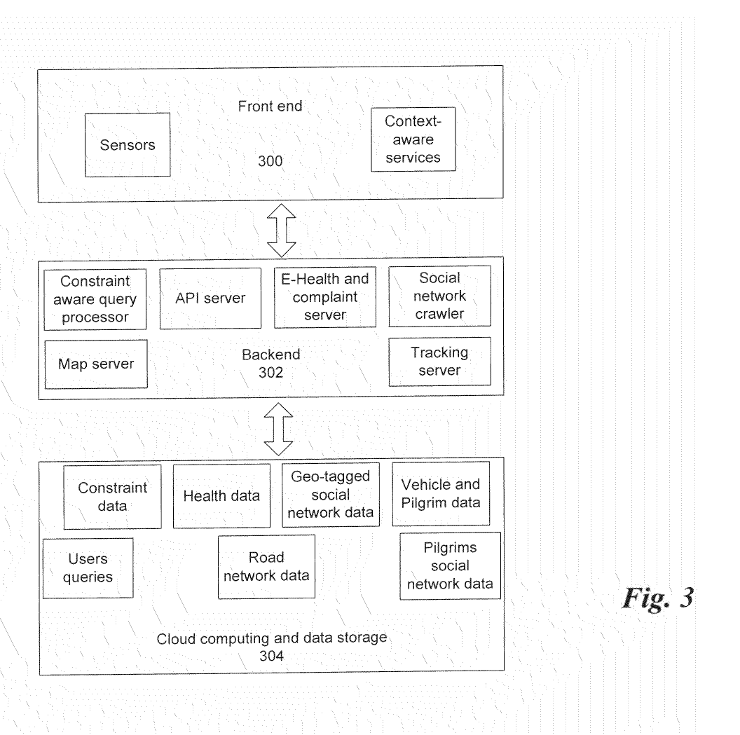

FIG. 3 is an exemplary block diagram representation of the server 100 architecture according to one example. The system architecture may be divided into three modules: a frontend module 300, a backend module 302 and a cloud computing and data storage module 304. The frontend module 300 handles the interaction with the user 104. The frontend module 300 may manage the sensors and the context aware services. The backend module 302 may handle the processing of data in one or more servers. In selected embodiments, the backend module may include a constraint aware query processor, an application programming interface (API) server, an E-health and complaint server, a social network crawler, a map server and a tracking server. The social network crawler collects data from social networks. The social network crawler may have parameters such as location, interests, activities and the like. The cloud computing and data storage 304 handles data storage. The data may be divided into different categories including road network data, constraint data, health data, geotagged social network data, vehicle and pilgrim data, user's queries, and user's social network data. Using cloud storage for the data permits scalability of the system and protection of the data. The road network data may include GPS coordinate of all roads in a city. The user's queries data represent past queries submitted by the users. The past queries may be used to provide the context aware services. For example, the server 100 may use the past queries data to determine that a service may be needed in a predetermined area. For example, the server 100 may determine that a high number of queries are identical and are related to the same area. For example, the server 100 may receive a high number of queries about the location of food services in a predetermined area. The server 100, using the CPU 1900, may then determine that the location of food service is needed in the predetermined area. The food service is then added to the subset of services available to the user 104 in the predetermined area.

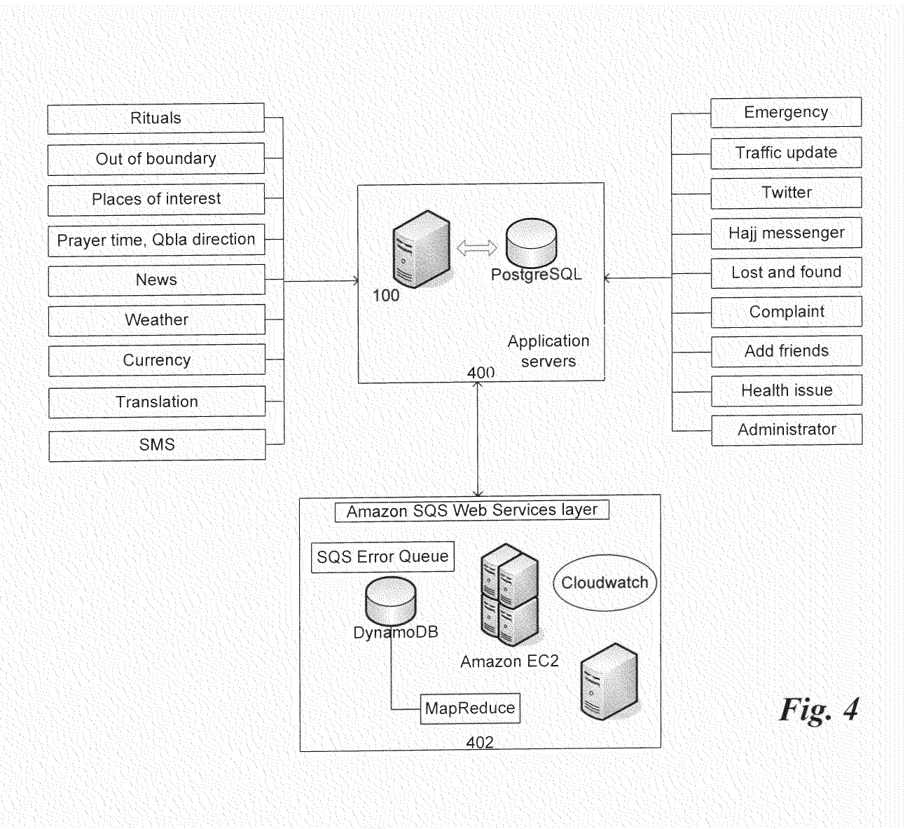

FIG. 4 is an exemplary block diagram representation of the server 100 architecture according to one example. In selected embodiments, the system may be implemented using an open source software architecture. The mobile device 106 may communicate with the server 100 using HTTP REST API that passes and receives the parameters in JavaScript Object Notation (JSON) format. The server 100 may receive information from the users in a plurality of ways. The users may send complaints and updates about traffic to the server 100. The server 100 may also gather information from social networking sites after basic level of analysis and systematic validation using the social network crawler as would be understood by one of ordinary skill in the art. A vehicle location may provide spatio-temporal information from the inbuilt GPRS/GSM sensors in a vehicle. Images and video obtained from the camera of the mobile device 106 may also be sent to the server 100. A PostgreSQL database contains all the spatial data like points of interest, users location, and OpenStreetMap based road network. The application servers 400 may include the server 100 and the PostgreSQL database. The application servers 400 may handle a plurality of services for the users such as rituals, out of boundary, places of interest, prayer time, news, weather, currency, translation, short message service (SMS), emergency, traffic update, complaint, lost and found, twitter, Hajj messenger, add friend, health issue and administrator. The server 100 receives requests from users. For example, the user 104 may send a request to the server 100 about nearby point of interest. The server 100 may then obtain the user location, run the spatial query on PostgreSQL database and return the results to the user interface of the mobile device 106. The data may be stored using cloud computing. For example, the system may use Amazon Web services (AWS) framework 402. To handle a large number of users the AWS may automatically scale up vertically and horizontally. Vertical scaling is changing the size of the servers while horizontal scaling is changing the number of servers. The server 100 may forward the multimedia data to AWS Simple Queue System (SQS). From SQS queue, Amazon Elastic Compute Cloud (EC2) server may read the data, process it, and store the data in Dynamo DB. In case, SQS queue reaches a predetermined threshold, the system may automatically increase the instance of EC2 for reading and processing the data from the queue. Dynamo DB is noSQL database service that makes it simple to store and to retrieve any amount of data.

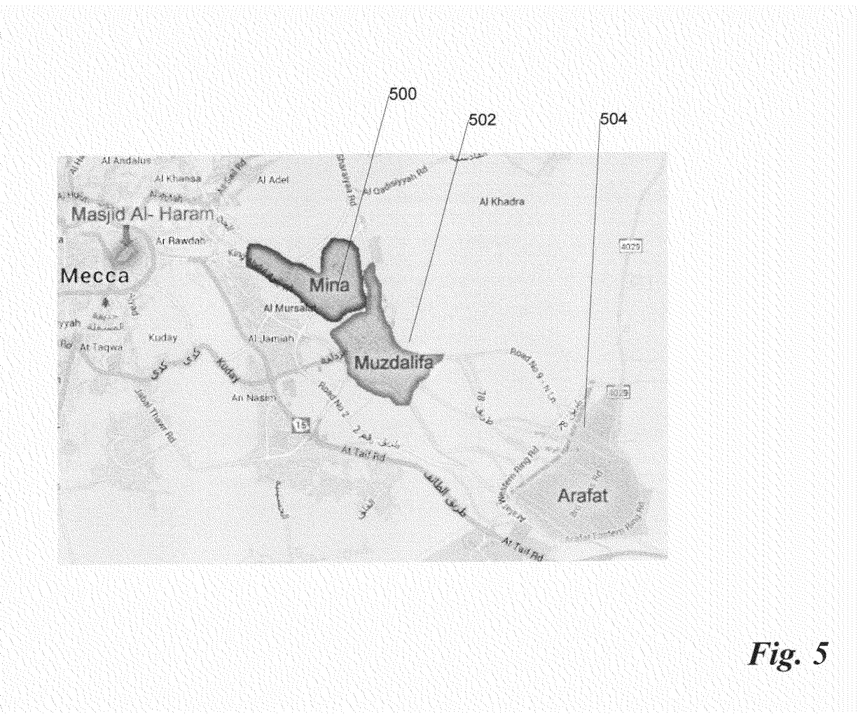

FIG. 5 is an exemplary map of a region with various predetermined areas highlighted. In one embodiment, the areas boundaries and locations may be as strictly defined in Islamic laws. The predetermined areas include Makkah city, Haram boundary, Mina, Muzdalifah, Arafat and Jamarat. FIG. 5 shows the predetermined areas “Mina” 500, “Muzdalifah” 502 and “Arafat” 504. The boundary of the predetermined area may be stored in the server 100 in terms of a set of latitude and longitude coordinates. In another embodiment, the set of latitude and longitude coordinates is stored in a memory of the mobile device 106. The boundary may be also defined by GPS coordinates or other coordinates depending on the system used. The mobile device 106 may also connect to the server 100 via the network 102 to verify that the coordinates stored in the memory of the mobile device 106 are up to date. In addition to the predetermined areas, the system may create temporal zones due to the association of the predetermined areas with the date and time. The predetermined areas visiting at different timings would be named as different temporal zones for examples visiting “Mina” at different timings and different days would be named as TZ11, TZ12, and TZ13.

FIG. 6 shows an exemplary user profile form stored in the memory 1902. The user profile may include one or more of, but not limited to, a name, a photo, a date of birth, a weight, a height, a gender, a skin color, a hair color, a next of kin and an identification number. In FIG. 6, the user profile includes at least one of the name, the photo, a fingerprint, an address, the date of birth, the height, the weight, the gender, an emergency contact number, a country, a list of languages, a list of friends, a list of family members, and a preferred language.

FIG. 7 shows exemplary user logs. The user log 700, 702 may include one or more of, but not limited to, a date, a name, a user identification number, a user location, a user activity, physiological readings, a health status. While FIG. 7 shows two user logs, it is understood that the server 100 may store several user logs corresponding to several users.

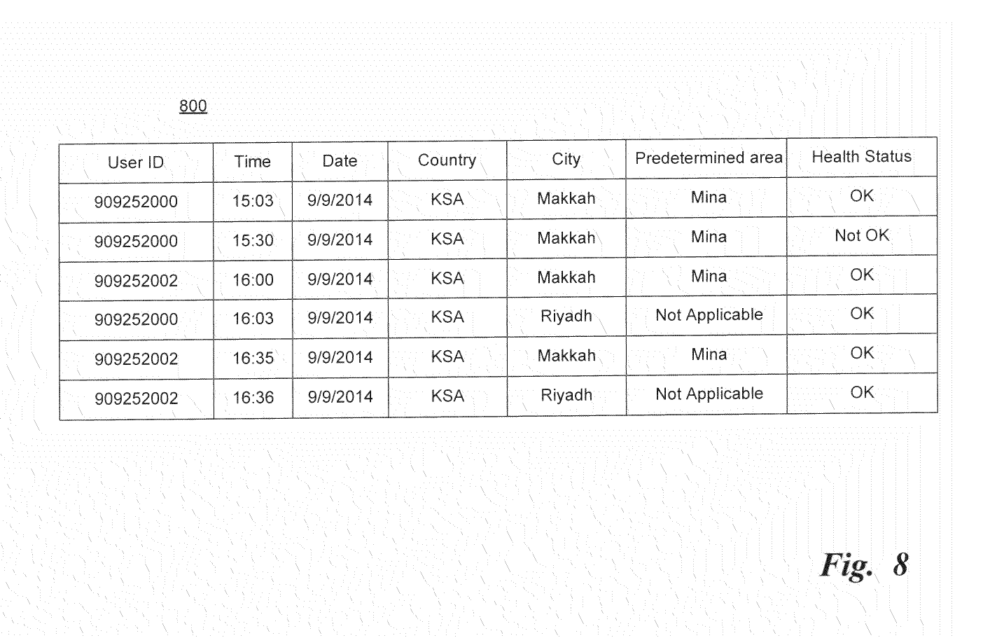

FIG. 8 shows a merged user log 800 from the user logs 700, 702 according to one example. The server 100 using the CPU 1900 may then produce the merged user log 800. The merged user log may be stored in the server 100. In selected embodiments, the server 100 using the CPU 1900 may analyze the merged user log to generate a service to the user. For example, the server 100 may receive, via the network 102 from the user, a query to request direction from the user location to a predetermined area. The server 100 may then find a possible route. The server 100 then may check whether the merged user log 800 for a last predetermined period of time contains information related to the possible route. In response to determining that a predetermined number of users during the last predetermined period of time indicated a problem in the possible route, the CPU 1900 may then find an alternative route. The CPU 1900 may also repeat the above steps for the alternative route. In response to determining that the alternative route has no problem. Then the CPU 1900 may choose the alternative route as the preferable route. The CPU 1900 then sends via the network 102 to the mobile device 106 of the user the direction. The directions may display on a map on the screen of the mobile device 106.

The server 100 may use primitive context to deduce a high-level context. Each sensory reading may have different possible primitive context. For example, using heart rate data several primitive contexts can be inferred: user heart rate high, user heart rate low, user heart rate normal and user heart rate alarming.

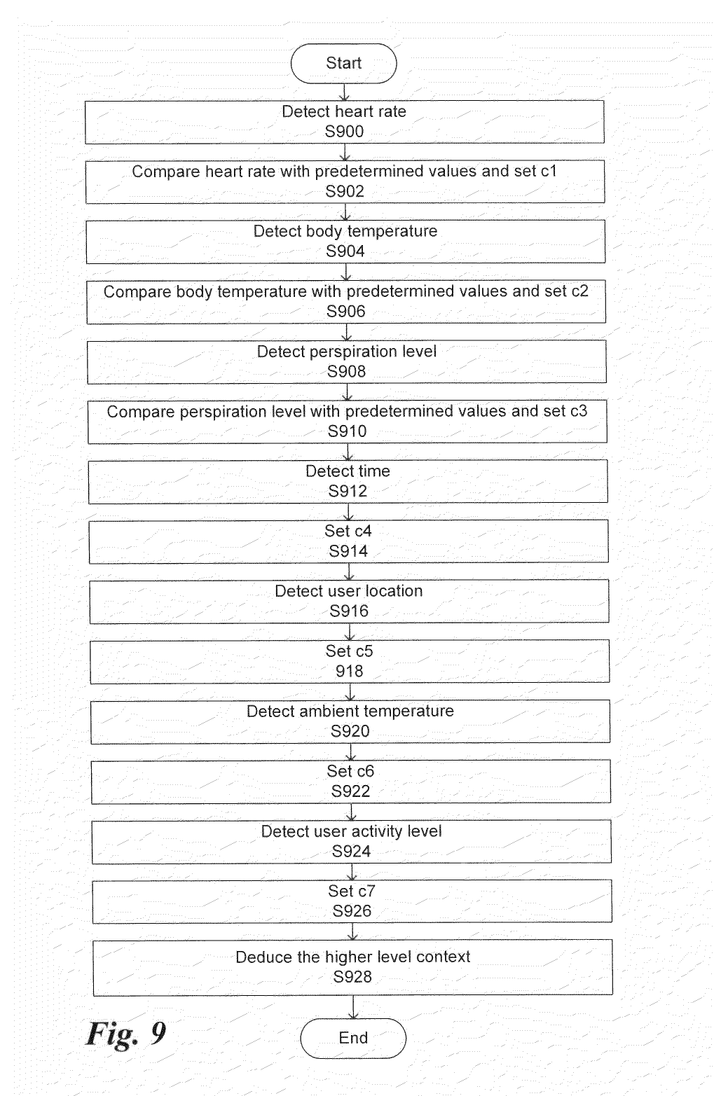

FIG. 9 is a flow chart that defines the user context according to one example. At S900, the heart rate is detected. The heart rate may be detected using a heart rate monitor connected to the mobile device 106. In other embodiments, the user 104 may enter the heart rate manually. Then, at S902, the heart rate is compared with predetermined values stored in the memory 1902. The predetermined values may be related to the user gender and age as would be understood by one of ordinary skills in the art. The server 100 may obtain the user gender and age from the user profile stored in the server 100 and shown in FIG. 6. The server 100 then determine a value for the heart rate context “high”, “low”, “normal” or “alarming”. For example, in response to determining that the heart rate is less than 60 the heart rate context of the user may be set to “low”. The server 100 sets the value of the heart rate context based on the analysis. The value is saved in the memory 1902. Next, at S904, the body temperature is detected. At step S906, the body temperature is then compared with predetermined values. The server 100, based on the comparison, sets the value of the body temperature context to “high”, “low”, or “normal”. Next, the server 100 at step S908 may detect a perspiration level using an appropriate sensor. In selected embodiments, the sensor may be a humidity sensor positioned on the user skin to detect the perspiration level. At step S910, the perspiration level is then compared to predetermined values. The CPU 1900 based on the comparison, sets the value of the perspiration context to “high”, “low”, or “normal”. At step S912, the current time is detected. The time may be obtained from the internal clock of the mobile device 106. At step S914, the time context is set. At step S916, the user location is detected. The user location may be determined as explained in FIG. 1. At step S918, the location context is set. At step S920, the ambient temperature is obtained. The ambient temperature may be obtained from online services based on the user location detected at step S916. At step S922, the ambient temperature context is set. At S924, the user activity level is detected. The user activity level may be detected using the accelerometer in the mobile device 106. In one embodiment, the user activity level detection method may be that disclosed in U.S Pat. No. 6,810,349 B2 entitled “SYSTEM AND METHOD FOR DETERMINING A MEASURE OF THE PHYSICAL ACTIVITY OF AN OBJECT”, the entire disclosure of which is incorporated herein by reference. At step S926, the activity level context is set. Then the server 100, at S928, may analyze the user context set at steps S900-S928 to determine the higher-level context. The analysis may be done by comparing the user context values with predetermined conditions. For example, c1 may represent the user heart rate (detected at step S900) and may be equal “high”, c2 may represent the user body temperature and may be equal to “high”, c3 may represent the user perspiration level and may be equal to “high”, c4 may represent the time and be equal to “midnight”, c5 may represent the user location and may be equal to “home”, c6 may represent the temperature and may be equal to “normal” and c7 may represent the user activity level and may be equal to “not moving”. The server 100 may compare the context value with the predetermined condition to deduce the higher-level context. For example, the server 100 may check whether the following condition is satisfied: cl=“high” and c2 =“high” and c3=“high” and c4=“midnight” and c5=“home” and c6=“normal” and c7=“not moving”. In response to determining that the condition is satisfied, the server 100 may deduce that the higher-level context is “stressed”.

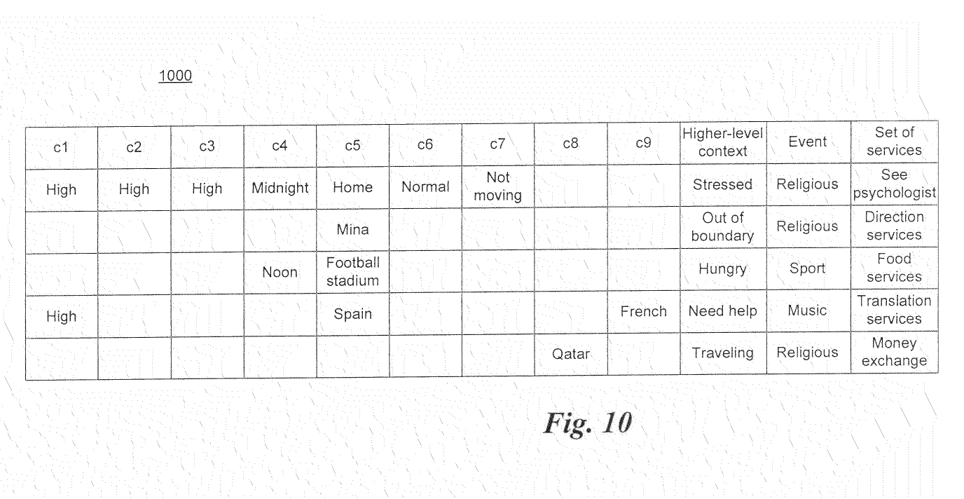

FIG. 10 is an exemplary chart that shows different user context according to one example. The chart 1000 shows that the higher-level context value may be equal to “stressed”, “out of boundary”, “hungry” or “lost”. The chart 1000 shows that the higher-level context is deduced from the user context (c1 to c9). The higher-level context may be deduced from one or more individual context (c1 to c9). The user context may be composed from any number of individual contexts. The server 100, using the higher-level context and the event determine the subset of services available to the user 104. For example, as shown in the chart 1000, if c1=“High” and c5=“Spain” and c9=“French”, the server 100 may determine that the user 104 “need help”.

The set of users may be represented as U={U₁, U₂, U₃, U₄, . . . Uₙ}. The set of services may be represented as S={S₁, S₂, S₃, S₄, . . . S₁} where S comprises all the services available for the users. The services may include services provided by third parties. For example, the services may include services provided by different governments around the world including Saudi government. The set of services may be divided into two types: ritual services and personal services. Personal services are those that the user needs for rest such as health services, finding point of interest, finding shortest paths, lost and found services, twitter services, currency service, news service, and weather service. Ritual services are those services that need to be followed to make the event successful. For example, the rituals that should be followed during Hajj. A subset of services chosen from the set of services is presented to the user 104. The higher-level context may be used to define the subset of services offered to the user 104.

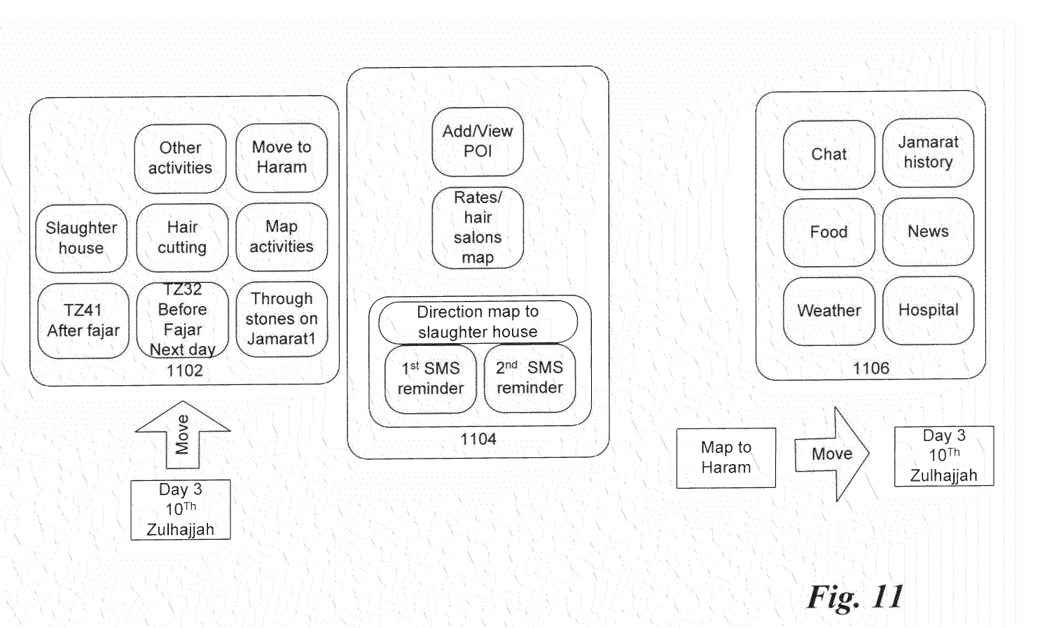

FIG. 11 is a block diagram representation of a subset of services provided to the user 104 based on a time and location association according to one example. Block 1102 shows the ritual services associated with the predetermined area. Block 1104 shows the personal services available to the user 104 in the predetermined area. Block 1106 shows the personal services that may be available to the user 104 in all areas but with content specialized to the current user location.

The user 104 may define a community of interest (COI). The community of interest may include family member, family physician, nearby friends, group leader or the like. The community of interest may also depend on the user context defined as explained and shown in FIG. 9. For example, during a health emergency the community of interest may include nearby hospitals, ambulance service and the like. The server 100 may automatically select the community depending on the user context. The community of interest is unique to each user. The COI for each user may expressed as: K={K₁, K₂, K₃, K₄, . . . Kₙ} where K is the set of different communities of interest. For example K1=family members, K2=friend K3=Hajj group fellows, K4=group management, K5=physician hospital, and K6=transport.

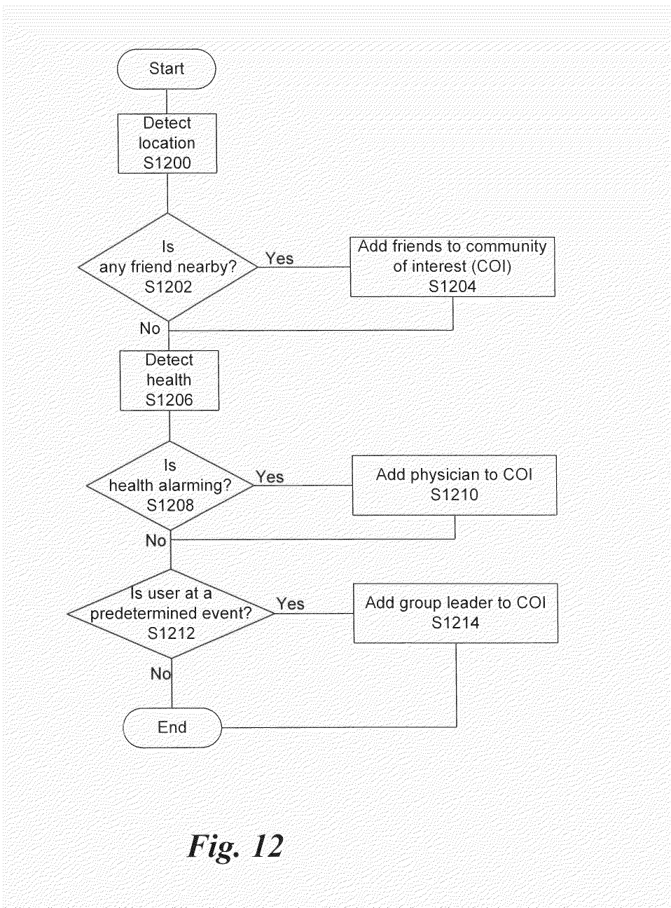

FIG. 12 is a flow chart to define the COI for the user 104 according to one example. At step S1100, the user current location is detected as explained and shown in FIG. 1. At S1202, the user location coordinates is then compared with the coordinates of friends location stored in the server 100 to determine whether one or more of the user friends are in a nearby location. The server 100 may compare the distance between the user 104 and the friend with a predetermined distance. The server 100 may determine that the friend is a nearby location in response to determining that the distance between the user 104 and the friend is less than the predetermined distance. The predetermined distance may be set according to the user preference. The predetermined distance may be saved in the memory of the mobile device 106. For example, the predetermined distance may be set to 2 km. The predetermined distance may be set according to the mode of transportation available to the user 104. For example, the predetermined distance set to 2 km is convenient for the user 104 who has access to a car while 500 m may be convenient for a pedestrian. In response to determining that the friend is in a nearby location, the friend is added to the community of interest of the user 104 at step S1204. The community of interest is updated in the server 100. The community of interest is then updated in the memory of the mobile device 106 via the network 102. Then, at step S1206, physiological readings are detected from health sensors. Then at S1208, the server 100 may analyze the physiological readings from the health sensors to determine the health status. The server 100 may compare the health sensor physiological reading with predetermined values saved in the memory 1902. In response to determining that the user health is not normal, the nearest physician to the user location (determined at step S1200) is added to the user community of interest at step S1210. In other embodiments, the server 100 using the CPU 1900 may obtain the health status from the user context. Then the server 100, at step S1212, may determine whether the user 104 is at a predetermined event. In response to determining that the user 104 is at a predetermined event, the community of interest is updated with a designated person. For example, in Hajj the community of interest may be updated with a group leader. The community of interest list may include the leader name and contact information. In selected embodiments, the community of interest of the user may include places. For example, the COI may include the nearest hospital to the user current location.

In selected embodiment, the COI of the user 104 may be used by the server 100 to determine the user location. For example, in response to failing to determine the user location using the mobile device 106. The server 100 may analyze the user community of interest stored in the server 100 to determine the list of nearby friends. The server 100 may then send an alert to the nearby friend notifying that the user 104 cannot be located. The nearby friends may then send information about the user 104 to the server 100 via the network 102. For example, the mobile device 106 may be offline due to low battery. The nearby friend may send the reason to the server 100. The server 100 may then update the user location in the user log 700.

A high level ritual comprises of a subset of primitive rituals R={R₁, R₂, R₃, . . . Rₘ} where R₁ are primitive rituals. Each primitive can be associated with a certain geometric boundary and temporal dimension. Rᵢ=Rᵢ(Z, T, Δt) where Z={Z₁, Z₂, Z₃, . . . Zₙ} are the predetermined areas as shown in FIG. 5 and T={T₁, T₂, T₃, . . . Tₘ} are temporal parameters and Δt is a possible duration the user 104 has to be in the predetermined area. An example of spatio-temporal characteristics is the location of primitive ritual called “staying in Arafat”, which is the predetermined area 504 where every pilgrim has to be present from afternoon of 9th day of 12th Hijri month and stay there until sunset of the same day. This primitive, along with other rituals has two dimensions: spatially the pilgrim has to be within Arafat boundary 504 and temporally the pilgrim has to be between afternoons to sunset of 9th day of 12th Hijri month. Similarly, all the primitive rituals can be broken down into a set of spatio-temporal dimensions.

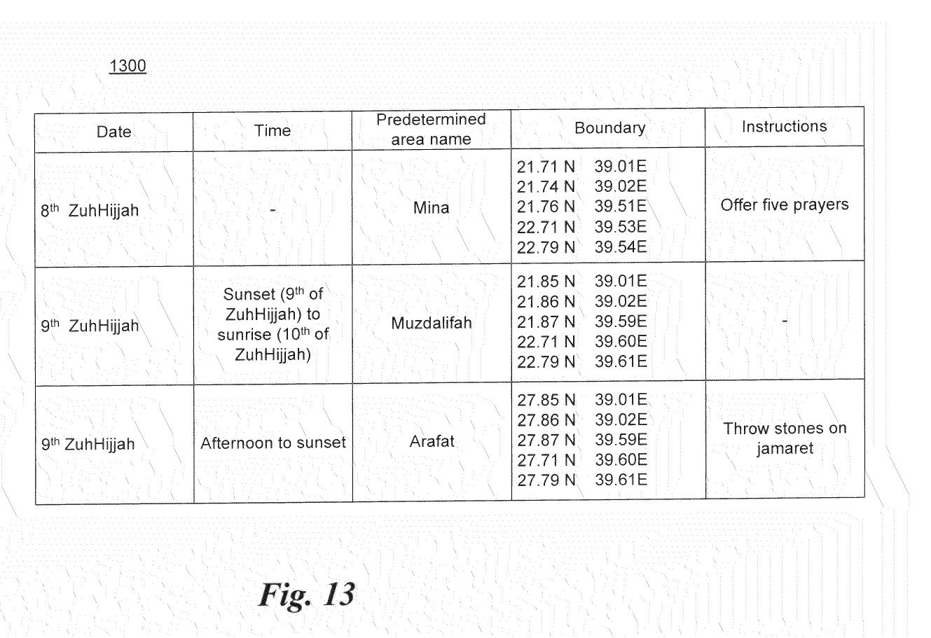

FIG. 13 shows an exemplary table to store information corresponding to an event. The information may include one or more date and times, one or more predetermined areas, a predetermined area boundary corresponding to the event. In selected embodiments, the event may be a religious event such as Hajj or Umrah. The event may extend over multiple days such in the case of Hajj. In other embodiments, the event may be a single day event such as Christmas day. In selected embodiments, the table may also include instructions corresponding to the event. The instructions may be the primitive rituals. For example, the instructions may describe the primitive rituals that have to be performed at the predetermined area corresponding to the date and time. For example, table 1200 shows that for the predetermined date “8^{th} Zil el Hijjah”, the predetermined area name is “Mina” and the instructions is to “offer five prayers”. The table 1300 may be stored in the memory of the mobile device 106. In other embodiments, the table 1300 may be stored in the server 100. The table 1300 may be updated by the administrator 112.

The event may have many types. Each type may have different set of rituals associated with the event. In one embodiment, the user 104 may indicate the type of event using the interface. In other embodiments, the server 100 may determine the type of the event by analyzing the user location and time. Once the type of event is determined, the server 100 may then provide the user 104 with the subset of services including the rituals associated with the type of event. For example, Hajj has two types: “Hajj Tamattu and Qiran” and “Hajj Afrad”. “Hajj Tamattu and Qiran” is the type of Hajj where Umrah is part of Hajj and “Hajj Afrad” is the type of Hajj where Umrah is not performed. For example, the user 104 is in the predetermined area “Haram” and starts to perform Hajj rituals, then the user 104 may perform Umrah or go to the predetermined area “Mina”. Some rituals may or may not have a time constraint. For example, the user 104 may perform Umrah at any time during Hajj. The rituals may be spatial and temporal. The set of rituals may or may not have a specific order. By capturing the user context, the server 100 may determine which ritual is being performed (or to be performed), and accordingly a set of relevant services are offered. For example, as shown in FIG. 11, the server 100 using the CPU 1900 may determine that the “hair cutting” ritual has to be performed and thus may include in the subset of services provided to the user “list of nearby hair salons”. In selected embodiments, depending on the current the temporal zone (time and date), one has to adjust himself to certain spatial zone, and then the set of rituals. In other embodiments, depending on the ritual, the system may suggest to the user the spatial and temporal zones. For example as shown in FIG. 11, due to the ritual “slaughter house”, the server 100 may include in the subset of services offered to the user “directions to the slaughter house”.

In selected embodiments, the user context may further include the user temporal and spatial context. For example, c5 may represent the date, c6 may represent the time, c7 may indicate that the user location is inside the predetermined area, and c8 may indicate that the user location is outside the predetermined area.

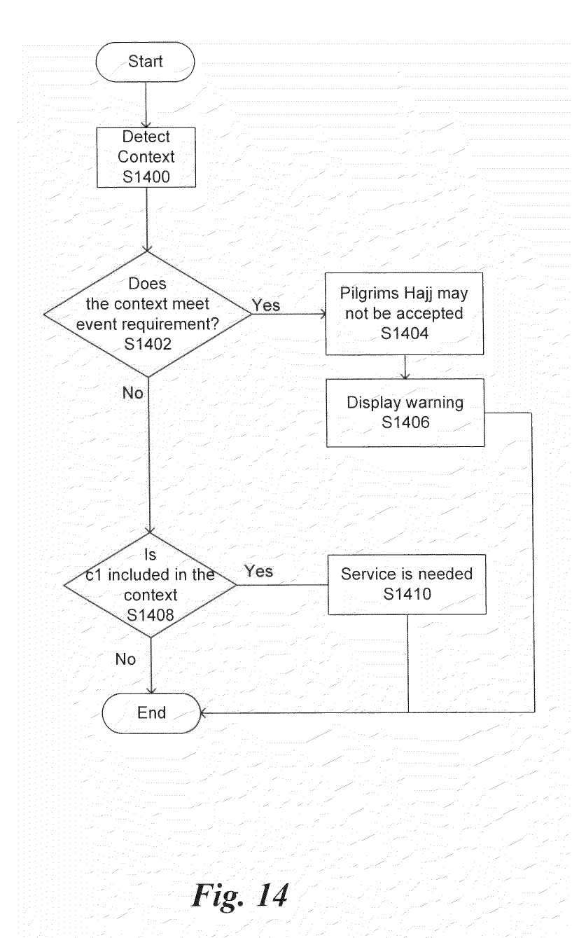

FIG. 14 is a flow chart shows a user status check according to one example. At step S1400, the server 100 may obtain the user context stored in the server 100. In selected embodiments, the server 100 may check whether the user context is up to date. The server 100 may compare the current time with the time when the user context has been saved in the server 100. In response to determining that the user context may be outdated, a new user context is obtained as explained in FIG. 9. The server 100, at S1402, may compare the user context with predetermined values. In response to determining that the user context does not meet the event requirement, the step goes to S1404. At S1404, the user event may be not accepted. For example, in case of Hajj, the Hajj may not be accepted as per Islamic law because the user 104 did not satisfy a predefined requirement. An alert may be generated and displayed on the mobile device 106 informing the user 104 that the hajj may not be accepted at step S1406. Then at S1408, the server 100 may check whether a predefined context is included in the user context. In response to determining that the predefined context is included, the server 100 may provide the user 104 with the corresponding service. For example, if c8 has a value other than “KSA” in the user context, the server 100 may automatically determine that the service of “money exchange” is needed as the country of the user is not KSA. Another example, the server 100 may check whether c9 has a value other than “English” in the user context. In response to determining, that c9 has a value different than “English” in the user context, the server 100 may automatically determine that a translator is needed as the user 104 primary language is not English. For example, as shown in FIG. 10, in response to determining that the user context c9 has a value equals to “French” the server 100 determine that the subset of service may include “translation services”.

In selected embodiments, the user context may be inferred from crowdsourcing techniques. For example, a road condition may be collected from social networks such as twitter. The information collected from crowdsourcing may also be used to provide appropriate service to the user 104. For example, the system after receiving a plurality of tweets regarding a road-blocked may recommend an alternate route. In one embodiment, the road recommendation method may be that disclosed in U.S Pat. No. 8,620,532 B2 entitled “PASSIVE CROWD-SOURCED MAP UPDATES AND ALTERNATE ROUTE RECOMMENDATIONS”, the entire disclosure of which is incorporated herein by reference.

In selected embodiments, the server 100 using the CPU 1900 depending on the event may conclude a user destination. The server 100 may then use the crowdsourcing techniques to obtain updated traffic information. The server 100 computes the preferable route based on the traffic information. The server 100 then sends the direction to the mobile device 106. The mobile device 106 then may automatically display the direction on the map on the user mobile device.

In selected embodiments, the user 104 may be the administrator 112. The administrator 112 may be an organizer, a government official or the like. In one embodiment, the server 100 using the CPU 1900 may check whether the user context is identified as the administrator. In other embodiments, the administrator 112 may need to be authorized. The authentication may be done by checking whether the mobile device 106 number the user 104 is using, is declared as the administrator 112. In response to determining that the user 104 is the administrator 112, additional services maybe available to the user. For example, the subset of services may include tracking users, viewing complaints and sending messages such as SMS to a plurality of users. The administrator 112 may represent a plurality of administrators.

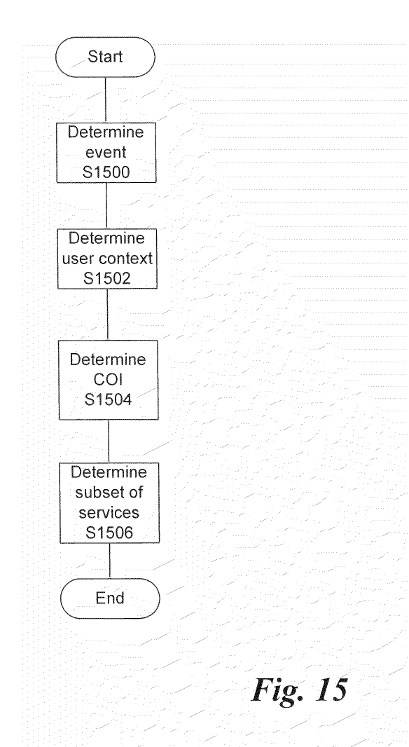

FIG. 15 is an exemplary flow chart of a context aware services generation system according to one example. At step S 1500, the server 100 may determine the event. The server 100 may check whether the current date and time corresponds with a date and time stored in the memory 1902. In response to determining that the current date and time corresponds with the date and time stored in the memory 1902, the server determine the event. For example, the server 100 may determine that the current date and time may be February 1 and 12 PM. Then the server 100 may determine that the current date and time corresponds with the date and time stored in the memory 1902 for the event “Super Bowl”. Then, at Step 1502, the server 1502 may determine the user context based on user data as shown and explained in FIG. 9. At step S1504, the server 100 may determine the user community of interest as shown and explained in FIG. 12. At step S1506, the server 100 may generate the subset of services based on the user context and the event (determined at S1500). An example of the subset of services generated is shown in FIG. 11.

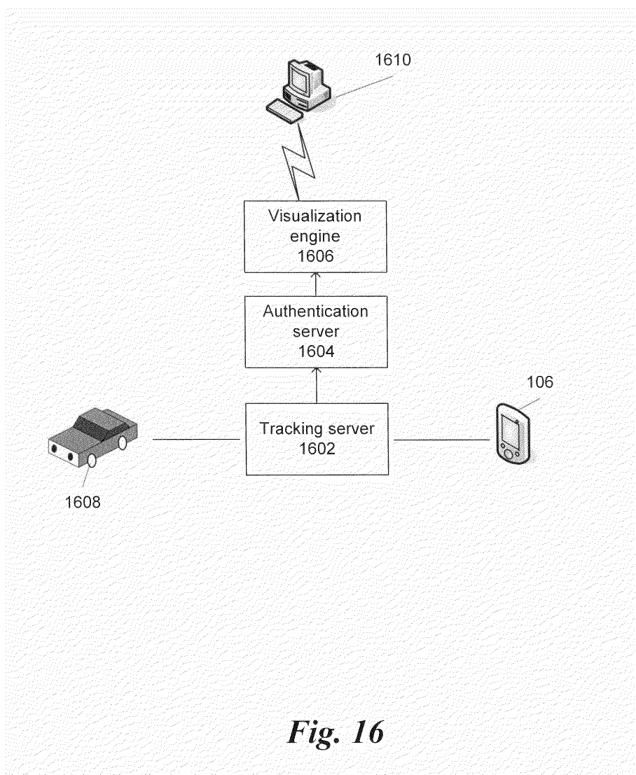

FIG. 16 is a block diagram representation of the tracking architecture according to one example. The administrator 112 may choose to track the mobile device 106 of the user. In another example, the administrator 112 may choose to track a vehicle 1608. The vehicle 1608 may be equipped with a GPS device. The administrator 112 may search for the user to track using the user identification number or the user name. The administrator 112 may choose the vehicle 1608 to track from an available list of vehicles stored in the application server 1602. For each of the vehicle 1608 or the user 104, the administrator 112 may choose to display on a computer 1610 the current location, live tracking, or the past location. The authentication server 1604 is responsible to check whether the administrator 112 is allowed to track the users. In response to determining that the administrator 112 is allowed to track the users, then the visualization engine 1606 may check the computer graphic requirements of the administrator's computer. The administrator's computer 1410 may be a laptop, a tablet or a smartphone. The tracking server 1602 may obtain and store vehicle location at a predetermined frequency. For example, the tracking server 1602 may obtain the vehicle location every 20 seconds. The tracking server 1602 may obtain the user location every 15 minutes. The predetermined frequency may be chosen based on the traveling speed of the user 104 or the vehicle 1608.

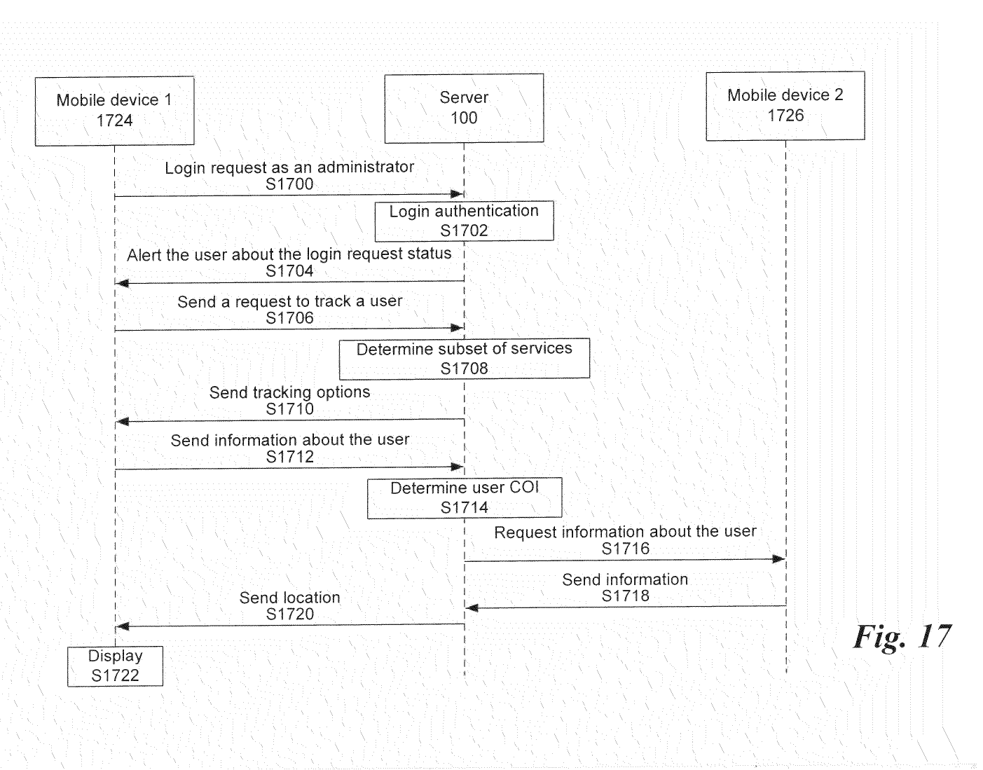

FIG. 17 is an exemplary flow chart for tracking a user according to one example. At step S1700, a first user using a first mobile device 1724 may transmit to the server 100 via the network 102 a request to login as the administrator 112. At step S 1702, the server 100 may perform login authentication by, for example, checking whether the first user mobile device number is registered as the administrator. At step S1704, in response to authenticating the first user, the server 100 may send an alert to the first user that the authentication as the administrator is successful. At step S1706, the first user may send a request to the server to track a lost user. At step S1708, the server 100 may determine the subset of services available to the first user based on the request. For example, the server 100 may determine that the first user can track the lost user on the map. At step S1710, the server 100 may send the tracking options available to the first user. At step S1712, the first user may send information to the server 100 about the lost user such as the user name or identification number. At step S1714, the server 100 checks the lost user COI stored in the memory 1902. Then, at step S1716, the server 100 may send information to a second user using a second mobile device 1726 about the lost user. The second user may be a friend of the lost user identified in the lost user COI. At step S1718, the second user may send information about the lost user to the server 100. The server 100 may user the information to determine the lost user location. At S1720, the server 100 may send the lost user location to the first user. At step S1722, the lost user location is displayed on the first user mobile device 1724.

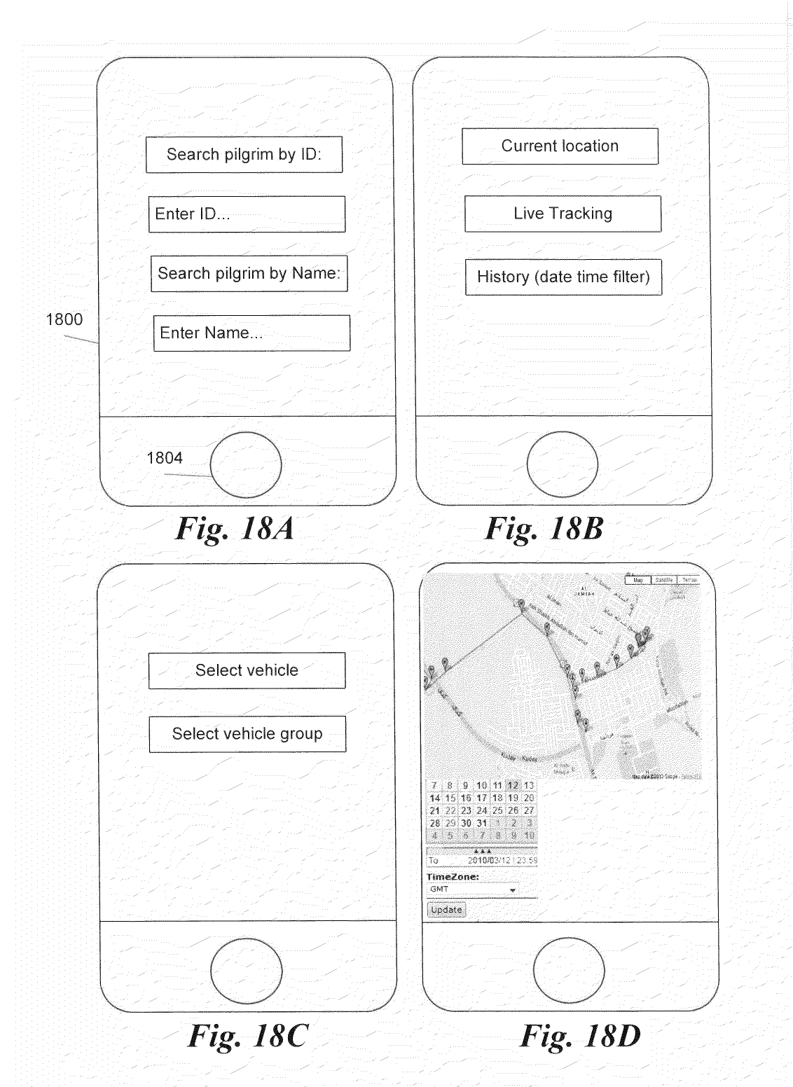

FIG. 18A,B,C,D are diagrams illustrating an exemplary user interface of a mobile device 106 using services available to the administrator 112. The mobile device 106 may be, for example, a tablet, a personal digital assistant, a cellular telephone or a smart phone. In one example, the mobile device 106 may include a touchscreen 1800 and a button 1804. The mobile device 106 may display options to the administrator. A user interaction with the alert may be received through the touchscreen 1800 or the button 1804. Processing the user interaction may include entering text, accepting or following the instructions displayed on the touchscreen 1800. FIG. 18A shows the options displayed on the screen of the administrator's mobile device. The administrator may search using the pilgrim's identification number or the pilgrim's name. FIG. 18B shows an exemplary interface to choose the type of tracking to be performed. FIG. 18C shows options to track a vehicle. FIG. 18D shows the option of tracking the vehicle 1608 on the map during a specific time frame.

The administrator 112 may add points of interest that is related to only a particular group of users like a bus stop or a mina tent. Once the administrator 112 has added a point of interest, an alert may be sent to the particular group of users indicating that the point of interest has been added. The administrator 112 may also update an existing point of interest stored in the memory 1902.

In selected embodiments, the administrator 112 may add users to the system. The administrator 112 may update the user profile shown in FIG. 6. The administrator 112 may also update missing road names, adding update point of interest names. The administrator 112 may also approve the POI added by users before showing the POI to other users. The administrator 112 can also delete or update the incorrect POIs. The administrator 112 has also access to emergency evacuation services. The emergency evacuation services are used so that the organizers are ready to respond to any disaster situation. The emergency evacuation services may give the organizers the projected time needed to evacuate the users from one location to another in case of an emergency situation. The server 100 may also analyze different possible evacuation route to choose a preferable route. The analysis may be based on several factors such as road traffic conditions and road type.

For example, in the case of an emergency situation with the user, the server may send via the network 102 to the mobile device 106 information showing the nearest hospital to the user location, transportation service available taking into consideration the dynamic road conditions, display on the user interface information related to the user COI such as contact numbers of nearby medical staff In addition, smartphones may disseminate lifesaving information such as current location of the event of the individual having severe health issues to the organizers.

The administrator 112 may also use SMS for emergency situation handling. SMS based live communication features is possible between hajj organizer office and bus driver, between muttawif office and a pilgrim, between hajj organizer office and group leader, and between group leader and the pilgrim. Hajj organizer can announce the bus schedule, which is allocated to the group of users.

FIG. 19 is an exemplary block diagram of the server 100 according to one embodiment. In FIG. 19, the server includes a CPU 1900 which performs the processes described above. The server is assumed to handle big data as millions of pilgrims can check it, thereby generating a very large amount of location data communicating with the server at any given time. The process data and instructions may be stored in memory 1902. These processes and instructions may also be stored on a storage medium disk 1904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the mobile device communicates, such as a server or computer.

Further, the claimed advancements may be provided as a utility application, background daemon, or component of an operating system, or combination thereof, executing in conjunction with CPU 1900 and an operating system such as Microsoft Windows 7, UNIX, Solaris, LINUX, Apple MAC-OS and other systems known to those skilled in the art.

CPU 1900 may be a Xenon or Core processor from Intel of America or an Opteron processor from AMD of America, or may be other processor types that would be recognized by one of ordinary skill in the art. Alternatively, the CPU 1900 may be implemented on an FPGA, ASIC, PLD or using discrete logic circuits, as one of ordinary skill in the art would recognize. Further, CPU 1900 may be implemented as multiple processors cooperatively working in parallel to perform the instructions of the inventive processes described above.

The server in FIG. 19 also includes a network controller 1906, such as an Intel Ethernet PRO network interface card from Intel Corporation of America, for interfacing with network 102. As can be appreciated, the network 102 can be a public network, such as the Internet, or a private network such as an LAN or WAN network, or any combination thereof and can also include PSTN or ISDN sub-networks. The network 102 can also be wireless such as a cellular network including EDGE, 3G and 4G wireless cellular systems. The wireless network can also be WiFi, Bluetooth, or any other wireless form of communication that is known.

The server further includes a display controller 1908, such as a NVIDIA GeForce GTX or Quadro graphics adaptor from NVIDIA Corporation of America for interfacing with display 1910, such as a Hewlett Packard HPL2445w LCD monitor. A general purpose I/O interface 1912 interfaces with a keyboard and/or mouse 1914 as well as a touch screen panel 1916 on or separate from display 1910. General purpose I/O interface also connects to a variety of peripherals 1918 including printers and scanners, such as an OfficeJet or DeskJet from Hewlett Packard.

A sound controller 1920 is also provided in server, such as Sound Blaster X-Fi Titanium from Creative, to interface with speakers/microphone 1922 thereby providing sounds and/or music.

The general purpose storage controller 1924 connects the storage medium disk 1904 with communication bus 1926, which may be an ISA, EISA, VESA, PCI, or similar, for interconnecting all of the components of the mobile device. A description of the general features and functionality of the display 1910, keyboard and/or mouse 1914, as well as the display controller 1908, storage controller 1924, network controller 1906, sound controller 1920, and general purpose I/O interface 1912 is omitted herein for brevity as these features are known.

A system which includes the features in the foregoing description provides numerous advantages to users. In particular, the device helps pilgrims perform Hajj with a peace of mind and in a correct manner without worrying about boundary guidelines, rituals and services. Other Hajj guides did not provide individualized alerts. The present disclosure addresses this concern by providing an easy method to guide and alert the users about various steps as required by religious laws (rituals) while providing individualized services based on the user current context and need. Thus, the present disclosure provides an improvement to the technical field by providing the user with individualized services during the event based on the user context. In addition the present disclosure presents a scalable architecture that permits the handling of a high number of users.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

The above disclosure also encompasses the embodiments listed below.

(1) A method for generating context aware services, including: storing, in a memory, a list of events; storing, in the memory, one or more dates and times corresponding to each event; receiving user data indicating a state of the user; determining, by processing circuitry, whether a current date and time corresponds with a date and time stored in the memory; determining, by the processing circuitry, an event in response to determining that the current date and time corresponds with the date and time; determining, by the processing circuitry, a user context based on the user data; and generating, by the processing circuitry, a subset of services based on the user context and the event.

(2) The method for generating context aware services of (1), further including: storing, in the memory, one or more predetermined areas corresponding to each event; determining, by the processing circuitry, a user location; and generating the subset of services wherein the generation is further based on the user location and a predetermined area corresponding to the event.

(3) The method for generating context aware services of any one of (1) or (2), wherein obtaining the user data includes: physiological readings including at least one of a heart rate, a body temperature and a blood pressure; and analyzing a user profile, wherein the determining of the user context is further based on the user profile.

(4) The method for generating context aware services of (3), wherein the user profile includes at least one of a name, a gender, spoken languages, and a preferred language.

(5) The method for generating context aware services of any one of (1) to (4), wherein determining the user context further includes: collecting, using crowdsourcing, information.

(6) The method for generating context aware services of any one of (1) to (5), further including: determining a type of event based on the user context; and generating the subset of services based on the type of event.

(7) The method for generating context aware services of any one of (1) to (6), further including: analyzing the user context to determine whether a predetermined context value is among the user context; and providing, in response to determining that the predetermined context is not among the user context, the subset of services.

(8) The method for generating context aware services of any one of (1) to (7), further including: storing, in the memory, data collected from a plurality of users; analyzing, using processing circuitry, the data to determine whether any friend of a user is nearby by comparing the user location with the data; adding a friend name to a user community of interest in response to determining that the friend is nearby; adding a group leader to the user community of interest in response to determining that the user is at a predetermined event; and adding a physician to the user community of interest in response to determining that the user health is alarming.

(9) The method for generating context aware services of any one of (1) to (8), further including: authenticating the user as an administrator; receiving an identification number and a request to locate the user; analyzing a community of interest of the user in response to failing to locate the user to determine nearby friends; providing to the user the location of the nearby friends; and sending an alert to a nearby friend to help locate the user.

(10) The method for generating context aware services of any one of (1) to (9), further including: analyzing the user context to determine a user destination; obtaining from social network traffic information; computing direction from the user current location to the user destination based on the traffic information; and displaying direction on the map on the display of the computing device.

(11) The method for generating context aware services of any one of (1) to (10), further including: analyzing the user context and the user data to determine whether the user satisfy a set of constraints; wherein the constrains are stored in the memory and are based on religion; and alerting the user in response to determining that the user does not satisfy the constraints.

(12) The method for generating context aware services of any one of (1) to (11), wherein the subset of services includes at least one of translation service, direction service, sms, weather services, news services, food services, and religious services.

(13) The method for generating context aware services of any one of (1) to (12), wherein the events are religious events including at least one of Hajj and Umrah.

(14) A system to generate context aware services, including: memory configured to store a list of events, and store one or more dates and times corresponding to each event; and processing circuitry configured to receive user data indicating a state of the user, determine whether a current date and time corresponds with a date and time stored in the memory, determine an event in response to determining that the current date and time corresponds with the date and time, determine a user context based on the user data, and generate a subset of services based on the user context and the event.

(15) The system to generate context aware services of (14), wherein the memory is further configured to store one or more predetermined areas corresponding to each event; and wherein the processing circuitry is further configured to determine a user location, and generate the subset of services wherein the generation is further based on the user location and a predetermined area corresponding to the event.

(16) The system to generate context aware services of (14) or (15), wherein obtaining the user data includes: physiological readings including at least one of a heart rate, a body temperature and a blood pressure; and analyzing a user profile, wherein the determining of the user context is further based on the user profile.

(17) The system to generate context aware services of (16), wherein the user profile includes at least one of a name, a gender, spoken languages, and a preferred language.

(18) The system to generate context aware services of any one of (14) to (17), wherein determining the user context further includes: collecting, using crowdsourcing, information.

(19) The system to generate context aware services of any one of (14) to (17), further comprising: determining a type of event based on the user context; and generating the subset of services based on the type of event.

(20) A non-transitory computer readable medium storing computer-readable instructions therein which when executed by a computer causes the computer to perform a method for generating context aware services, the method including: storing, in a memory, a list of events; storing, in the memory, one or more dates and times corresponding to each event; receiving user data indicating a state of the user; determining, by processing circuitry, whether a current date and time corresponds with a date and time stored in the memory; determining, by the processing circuitry, an event in response to determining that the current date and time corresponds with the date and time; determining, by the processing circuitry, a user context based on the user data; and generating, by the processing circuitry, a subset of services based on the user context and the event.

1. A method for generating context aware services, comprising:
storing, in a memory, a list of events;
storing, in the memory, one or more dates and times corresponding to each event;
receiving user data indicating a state of the user;
determining, by processing circuitry, whether a current date and time corresponds with a date and time stored in the memory;
determining, by the processing circuitry, an event in response to determining that the current date and time corresponds with the date and time;
determining, by the processing circuitry, a user context based on the user data; and
generating, by the processing circuitry, a subset of services based on the user context and the event.

2. The method of claim 1, further comprising:
storing, in the memory, one or more predetermined areas corresponding to each event;
determining, by the processing circuitry, a user location; and
generating the subset of services wherein the generation is further based on the user location and a predetermined area corresponding to the event.

3. The method of claim 1, wherein obtaining the user data includes:
physiological readings including at least one of a heart rate, a body temperature and a blood pressure; and
analyzing a user profile, wherein the determining of the user context is further based on the user profile.

4. The method of claim 3, wherein the user profile includes at least one of a name, a gender, spoken languages, and a preferred language.

5. The method of claim 1, wherein determining the user context further includes:
collecting, using crowdsourcing, information.

6. The method of claim 1, further comprising:
determining a type of event based on the user context; and
generating the subset of services based on the type of event.

7. The method of claim 1, further comprising:
analyzing the user context to determine whether a predetermined context value is among the user context; and
providing, in response to determining that the predetermined context is not among the user context, the subset of services.

8. The method of claim 1, further comprising:
storing, in the memory, data collected from a plurality of users;
analyzing, using processing circuitry, the data to determine whether any friend of a user is nearby by comparing the user location with the data;
adding a friend name to a user community of interest in response to determining that the friend is nearby;
adding a group leader to the user community of interest in response to determining that the user is at a predetermined event; and
adding a physician to the user community of interest in response to determining that the user health is alarming.

9. The method of claim 1, further comprising:
authenticating the user as an administrator;
receiving an identification number and a request to locate the user;
analyzing a community of interest of the user in response to failing to locate the user to determine nearby friends;
providing to the user the location of the nearby friends; and
sending an alert to a nearby friend to help locate the user.

10. The method of claim 1, further comprising:
analyzing the user context to determine a user destination;
obtaining from social network traffic information;
computing direction from the user current location to the user destination based on the traffic information; and
displaying direction on the map on the display of the computing device.

11. The method of claim 1, further comprising:
analyzing the user context and the user data to determine whether the user satisfy a set of constraints;
wherein the constrains are stored in the memory and are based on religion; and
alerting the user in response to determining that the user does not satisfy the constraints.

12. The method of claim 1, wherein the subset of services includes at least one of translation service, direction service, sms, weather services, news services, food services, and religious services.

13. The method of claim 1, wherein the events are religious events including at least one of Hajj and Umrah.

14. A system for generating context aware services, comprising:
memory configured to
store a list of events, and
store one or more dates and times corresponding to each event; and
processing circuitry configured to
receive user data indicating a state of the user,
determine whether a current date and time corresponds with a date and time stored in the memory,
determine an event in response to determining that the current date and time corresponds with the date and time,
determine a user context based on the user data, and generate a subset of services based on the user context and the event.

15. The system of claim 14, wherein the memory is further configured to
store one or more predetermined areas corresponding to each event; and
wherein the processing circuitry is further configured to
determine a user location, and
generate the subset of services wherein the generation is further based on the user location and a predetermined area corresponding to the event.

16. The system of claim 14, wherein obtaining the user data includes:
physiological readings including at least one of a heart rate, a body temperature and a blood pressure; and
analyzing a user profile, wherein the determining of the user context is further based on the user profile.

17. The system of claim 16, wherein the user profile includes at least one of a name, a gender, spoken languages, and a preferred language.

18. The system of claim 14, wherein determining the user context further includes:
collecting, using crowdsourcing, information.

19. The system of claim 14, further comprising:
determining a type of event based on the user context; and
generating the subset of services based on the type of event.

20. A non-transitory computer readable medium storing computer-readable instructions therein which when executed by a computer causes the computer to perform a method for generating context aware services, the method comprising:
storing, in a memory, a list of events;
storing, in the memory, one or more dates and times corresponding to each event;
receiving user data indicating a state of the user;
determining, by processing circuitry, whether a current date and time corresponds with a date and time stored in the memory;
determining, by the processing circuitry, an event in response to determining that the current date and time corresponds with the date and time;
determining, by the processing circuitry, a user context based on the user data; and
generating, by the processing circuitry, a subset of services based on the user context and the event.
